(19) United States
(12) Patent Application Publication
(10) Pub. No.: US 2016/0097705 A1
(43) Pub. Date: Apr. 7, 2016

(54) NON-INSTRUSIVE FILTER SCANNING

(71) Applicant: CAMFIL USA, INC., Riverdale, NJ (US)

(72) Inventor: Keith G. WOOLARD, Washington, NC (US)

(21) Appl. No.: 14/869,257

(22) Filed: Sep. 29, 2015

Related U.S. Application Data
(60) Provisional application No. 62/059,990, filed on Oct. 5, 2014.

(51) Int. Cl. G01N 15/08; G01N 21/88

(52) U.S. Cl. CPC G01N 15/082; G01N 21/88; G01N 2015/084; G01N 2201/104; G01N 2201/06113

(57) ABSTRACT

Embodiments of the disclosure generally include a scan module configured to scan a filter for leaks. In one example, the scan module includes a housing having a plurality of scan probes disposed therein. A movement mechanism is coupled to the plurality of scan probes. The movement mechanism is operable to simultaneously displace the plurality of scan probes within the housing.

### CROSS-REFERENCE TO RELATED APPLICATIONS

This application claims benefit of U.S. Provisional Application Ser. No. 62/059,990, filed Oct. 5, 2014 (Attorney Docket No. CMFL/107USL), of which is incorporated by reference in its entirety.

### BACKGROUND

1. Field

The present invention generally relates to a housing assembly having a non-intrusive mechanism for filter testing, and more specifically, a contamination housing assembly for an air filter having a scan probe array for filter testing and the like.

2. Description of the Related Art

Contamination housing assemblies are used in critical processes where hazardous airborne materials must be prevented from escaping to the atmosphere. A filter is disposed in the contamination housing assembly to remove the hazardous and other materials from the air stream passing though the housing assembly. The housing assembly may be configured to include at least one replaceable filter, such as a particulate filter, such as a HEPA filter, and/or molecular filters for absorbing molecular contaminants.

The filters disposed in the contamination housing assembly are periodically replaced using a control barrier to protect change-out personnel from contaminants within the housing and from contaminants captured by the filters. The typical control barrier utilized is a plastic bag enclosure system such as described in U.S. Pat. No. 3,354,616, issued Nov. 28, 1967. The use of a plastic bag to remove and replace filters from a contamination housing assembly is typically known as a bag-in/bag-out procedure.

Once a new filter has been installed in the containment housing, the new filter is tested for leaks, such as pin holes and other defects, to ensure hazardous and other materials will be properly removed from the air stream passing though the filter. An aerosol challenge is dispersed upstream of the filter by an aerosol generator. In conventional contamination housings, a testing port is opened downstream of the filter to allow a hand-held scanning probe to obtain samples from the downstream side the filter. A contamination barrier, such as a second bag, is utilized to prevent any hazardous and other materials from escaping the housing while the backside of the filter is manually scanned for leaks using the probe. The probe is moved in a pattern along the entire backside of the filter to ensure the filter is fully tested for any leaks. Upon successful completion of the filter testing, the testing port is sealed and the contamination housing and filter are ready for normal operation.

Thus, testing of the replacement filter is a costly and time consuming event. Furthermore, the potential for the release of hazardous materials increases with each opening of the containment housing. With the increasing severity of the biomedical, radiological and carcinogenic contaminants present in the air streams filtered utilizing containment housings, the continuing need to ensure each filter is leak-free after the replacement filter has been installed in the contamination housing is of increasing importance so that the hazardous materials in the air stream entering the housing are not release downstream of the filter.

Thus, there is a need for an improved non-intrusive filter testing apparatus suitable for use in a contamination housing.

### SUMMARY

Embodiments of the disclosure generally include a scan module configured to scan a filter for leaks. In one example, the scan module includes a housing having a plurality of scan probes disposed therein. A movement mechanism is coupled to the plurality of scan probes. The movement mechanism is operable to simultaneously displace the plurality of scan probes within the housing.

In another embodiment, a filter housing assembly is provided that includes a filter housing and a scan module. The filter housing has an inlet, an outlet, a filter mount, and a filter access port. The scan module is positioned between the filter mount and the outlet. The scan module includes a movement mechanism coupled to a plurality of scan probes. The movement mechanism is operable to simultaneously displace the plurality of scan probes in a direction perpendicular to a direction of air flow within the housing between the inlet and the outlet.

In yet another embodiment, a method for scanning a filter is provided. In one embodiment, the method includes introducing a challenge aerosol upstream from a first filter secured in a housing, simultaneously moving a first plurality of sample probes in a single sweep across a downstream face of the first filter, and determining leaks in the first filter by utilizing samples collected by the probe assembly.

### BRIEF DESCRIPTION OF THE DRAWINGS

The teachings of the present invention can be readily understood by considering the following detailed description in conjunction with the accompanying drawings, in which:

FIG. 1 is a cross-sectional view of one embodiment of a contamination housing having a scan module; and

FIG. 2 is perspective view of the scan module equipped with a probe assembly.

FIG. 3 is a partial plan view of the scan module showing alternate movement mechanisms for displacing the probe assembly.

FIG. 4 is a block diagram a method for detecting leaks in a filter using the scan module.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

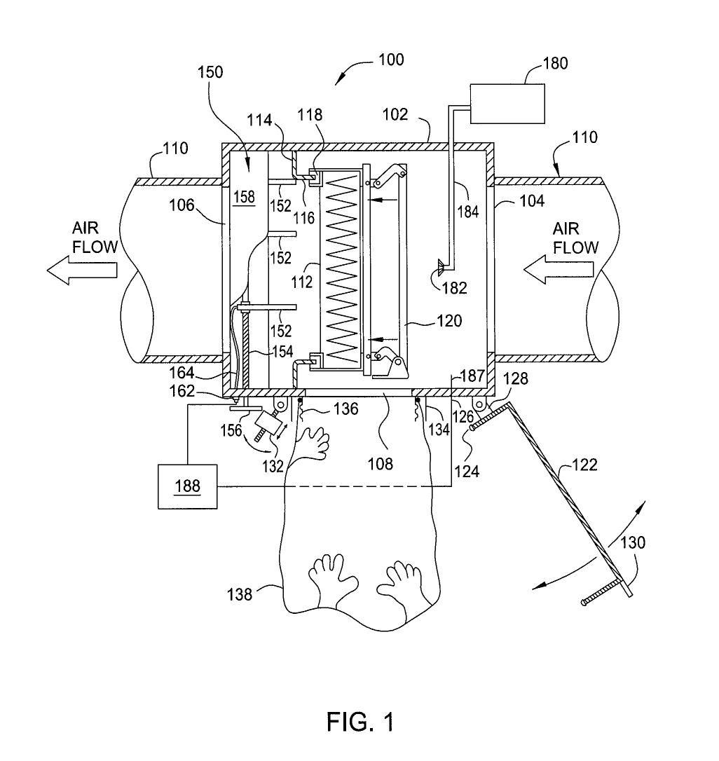

FIG. 1 is a sectional view of one embodiment of a contamination housing assembly 100 equipped with a scan module 150. The housing assembly 100 generally includes a housing 102 having an inner volume 186, an inlet 104, an outlet 106 and a filter access port 108. The inlet 104 is formed in an upstream portion of the housing 102 and outlet 106 is formed in a downstream portion of the housing 102. Ductwork may be used to attach the inlet 104 and outlet 106 of the housing assembly 100 to an air handling system (not shown). The inlet 104 and outlet 106, formed through the housing 102, allow gases to flow through a duct 110 and pass through the inner volume 186 of the housing 102. The filter access port 108 is configured to permit access to the inner volume 186 of the housing 102, for example, for filter change-out, and the like.

The housing 102 may be fabricated from a metal, such as aluminum, steel and stainless steel, or other suitable material. The housing 102 has a construction that forms a pressure barrier between gases flowing through the inner volume 186 of the housing 102 and an ambient environment 190 present outside of the housing 102. In the embodiment depicted in FIG. 1, the housing 102 is a hollow rectangular body fabricated from continuously welded metal sheets.

The housing 102 additionally includes an internal flange 114 that sealingly engages one or more replaceable filter 112 disposed in the inner volume 186 of the housing 102. Although only one filter 112 is illustrated in FIG. 1, additional filters 112 may be disposed laterally to the side and/or above the illustrated filter 112, for example, in an M×N array, where M, a positive integer, is the number of filters 112 disposed in a first direction perpendicular to the airflow direction through the contamination housing assembly 100, while N, a positive integer, is the number of filters 112 disposed in a second direction perpendicular to the airflow direction through the contamination housing assembly 100, the first direction being perpendicular to the second direction. In one embodiment, the internal flange 114 includes a knife edge 116 that sealingly engages a fluid or gasket seal 118 disposed on or in a frame of the filter 112. The seal between the housing 102 and the filter 112 forces air traveling through the inner volume 186 of the housing 102 to pass through the filter 112. A linkage mechanism 120 is provided in the housing 102 and is configured to move the filter 112 between a position sealingly engaged with the internal flange 114 and a position clear of the internal flange 114. Alternatively, the internal flange 114 may include a flat ring for sealingly engaging the seal 118 of the filter 112 in certain embodiments in which the seal 118 is configured as a gasket.

The filter access port 108 is configured to facilitate removal of the filter 112 from the housing 102 and is selectively sealed by a door 122. The door 122 is coupled to the housing 102 by a hinge 128. The door 122 includes a seal 124 that engages a face 126 of the housing 102 when the door 122 is in a closed position, thus sealing the filter access port 108.

The filter access port 108 is circumscribed by a flange 134 and a bagging ring 136. The flange 134 extends from the face 126 of the housing 102 and circumscribes the bagging ring 136. The flange 134 is utilized to keep a bag 138, coupled to the bagging ring 136, clear of the seal 124 as the door 122 is closed.

A clamp 132 is provided to secure the door 122 when in a closed position. In the embodiment depicted in FIG. 1, the clamp 132 may be a knob disposed on a threaded stud. The clamp 132 is adapted to selectively engage a locking tab 130 extending from the door 122. With the door 122 in the closed position, the knob of the clamp 132 may be positioned to engage a locking tab 130 extending from the door 122, such that the seal 124 may be compressed against the face 126 of the housing 102, for example, by tightening the knob on the threaded stud. Thus, the filter access port 108 for changing the filter 112 may be sealed and ensure air flowing through the inner volume 186 of the housing 102 is directed through the filter 112.

An aerosol generator 180 may be attached the inner volume 186 of the housing 102 via a pipe 184 upstream of the filter 112. The aerosol generator 180 may introduce a challenge aerosol into the inner volume 186 of the housing through a nozzle 182. The nozzle 182 may be disposed within the inner volume 186 of the housing 102 upstream of the filter 112 to promote uniform distribution of the challenge aerosol concentration across the filter 112. The challenge aerosol may be a dioctyl phthalate (DOP), NaCL cube, poly alpha olefin (PAO), polystyrene latex sphere (PSL), or other challenge aerosol suitable for testing the filter which is also compatible with the test equipment 188. The challenge aerosol may contain particles having a mean diameter of between about 0.1 um to about 5.0 um, for example between about 0.2 and about 0.3 μm. The aerosol generator 180 may release the challenge aerosol into the inner volume 186 of the housing 102 at a concentration between about 10 mg/m³ and 100 mg/m³, such as between about 20 mg/m³ and about 80 mg/m³. If a particle count in excess of a predetermined value is detected downstream of the filter 112, the area of the filter 112 from which the high particle count sample was obtained may be rechecked for continuous counts. If continuous counts in excess of the specified leakage threshold are detected, the leak may be repaired or the filter replaced.

The scan module 150 is disposed downstream of the filter 112 in the inner volume 186 of the housing 102 for detecting the challenge aerosol. The scan module 150 may be an integral part of the housing 102 or a separate component attached to the housing 102. The air flowing into the inner volume 186 from the inlet 104 of the housing 102 and past the nozzle 182, flows through the filter 112 prior to flowing through the scan module 150.

The scan module 150 has a body 158 and a sealed bulkhead 160. The sealed bulkhead 160 prevents airflow from leaking from the inner volume 186 to the outside environment 190 of the housing 102. Alternately, the sealed bulkhead 160 may be part of the housing 102. In this manner, an operator on the outside environment 190 of the housing 102 may interact with scan module 150 while isolated from the airflow within the housing 102.

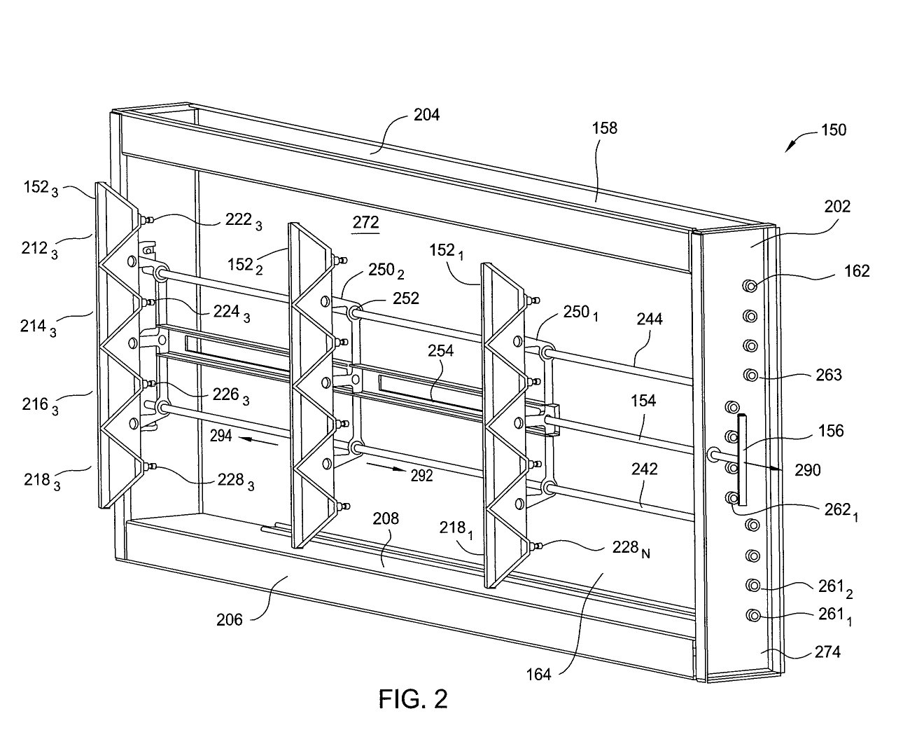

The scan module 150 is configured with one or more probe assemblies 152. The probe assembly 152 may consist of one or more sampling probes, such as the sample probes 212 shown in FIG. 2. The sample probes 212 may have design configuration suitable for particulate scan testing. In one embodiment, the sample probes 212 conform to IEST-RP-CC034.1 Recommended Practices. The sample probes 212 are generally configured to have an opening 155 sized to allow iso-kinetic sampling at a predefined filter test velocity.

The probe assemblies 152 traverse over the inner volume 186 of the housing 102 adjacent to the downstream face of the filter 112. For example, the probe assemblies 152 may be positioned about 1 inch from the downstream face of the filter 112. The probe assemblies 152 are configured to move in unison by way of a movement mechanism 156. The movement mechanism 156 may be configured to move all probe assemblies 152 linearly at the same time. The movement mechanism 156 may be configured to move the sample probes 212 in fashion as prescribed in IEST-RPCC034.1, or other suitable test protocol. The movement mechanism 156 may or may not extend through the sealed bulkhead 160 and be configured to move the sampling probes 212 of the probe assemblies 152 across the entire face of the filter 112.

Each sampling probe 212 of the probe assemblies 152 may generally be coupled by a conduit 164 to a downstream sample port 162 defined through the sealed bulkhead 160 or the housing 102. Each conduit 164 couples one sampling probe 212 to one sampling port 162. The sample ports 162 are sealed to the sealed bulkhead 160 or the housing 102. The sample ports 162 may include, or have coupled thereto, a quick disconnect to facilitate coupling test equipment to the sample port 162. The quick disconnect may include an integral check valve to prevent leakage through the sample port 162 when no test equipment is attached.

The conduits 164 may be formed from a fluid tight and flexible material. For example, the conduits 164 may be formed from plastic or elastomeric tubing, or flexible metal tubing, or other suitable material. The flexible nature of the conduits 164 permits the movement of the probe assemblies 152 without the conduits 164 constricting the fluid flowing therein or leaking fluid.

The sampling port 162 may be fluidly attached to a test equipment 188, such as a photometer or particle counter. The test equipment 188 may also be coupled to the upstream sample port 189 in the housing 102. The test equipment 188 may represent one or more photometer or particle counters. For example, each sampling port 162 may have its own test equipment 188 attached thereto so that the test equipment 188 may simultaneously detect particles sampled through each sample probe 212. The test equipment 188 may operate by detecting or measuring light scattering, light obscuration, or by direct imaging. In one embodiment, the test equipment 188 is an aerosol particle counter and determines the air quality by counting and sizing the number of particles in the air. A high energy light source is used to illuminate the particle as it passes through the detection chamber of the test equipment 188. The particle passes through the light source (typically a laser or halogen light) and if light scattering is used, then a photo detector detects the redirected light. If direct imaging is used, a halogen light illuminates particles from the back within a cell while a high definition, high magnification camera records passing particles. Recorded video is then analyzed by computer software to measure particle attributes. If light blocking (obscuration) is used, the test equipment 188 detects the loss of light. The amplitude of the light scattered or light blocked is measured and the particle is counted and tabulated into standardized counting bins. Leaks in the filter 112 may be determined by the test equipment 188 when 0.01% or greater of the upstream challenge aerosol is detected at the sample port 162. Other test equipment 188 may alternatively be utilized.

In one embodiment, the filter 112 is tested for leaks. The aerosol generator 180 releases a challenge aerosol upstream of the filter. Air flowing toward the filter 112 is mixed to provide a uniform concentration of the challenge aerosol. Air passing through the filter 112 is tested for presence of the challenge aerosol. The scan module 150 on the downstream side of the filter 112 collects the air flowing through the filter 112 in the opening 155 of the sample probes 212. The air collected by sample probes 212 is directed out the sample port 162 to the test equipment 188 for determining if there is a leak at the location of the sample probe 212. The movement mechanism 156 advances the probe assemblies 152 to scan the face of the filter 112 in a single pass. Since the filter 112 may be tested in a single pass, the labor costs and system down time is greatly reduced over conventional systems.

FIG. 2 is perspective view of the scan module 150 equipped with a plurality of probe assemblies 152. The scan module 150 has an inner volume 272 which is surrounded by the body 158 of the scan module 150. The scan module may additionally have a top 277, a bottom 276 and sidewalls 274, 275 which surround the inner volume 272. The scan module 150 has an upstream side 206. The upstream side 206 faces the internal flange 114 that sealingly engages the one or more replaceable filters 112. The air flowing through the one or more replaceable filters 112 flows into the scan module 150 through the upstream side 206. The scan module 150 also has a downstream side 208. Air entering the inner volume 272 of the scan module 150 from the upstream side 206 exits the inner volume 272 through the downstream side 208 of the scan module 150.

The scan module 150 may have a support structure 248 disposed in the inner volume 272. The support structure 248 may be attached to one or more of the sidewalls 274, 275, the top 277 or the bottom 276 of the scan module 150. The support structure 248 may comprise smooth rod, threaded rod, a box beam, “C” channel or other member suitable for providing structural support. The support structure 248 may include an upper linear guide 244 and a lower linear guide 242. The upper and lower linear guides 244, 242 may be substantially similar. Alternately, the upper and lower linear guides 244, 242 may be substantially different. In one embodiment, the upper and lower linear guides 244, 242 are in the inner volume 272 of the scan module and comprised of smooth steel bearing rods fastened to the sidewalls 274, 275 of the scan module 150.

Opposite one or more of the top 277, the bottom 276 or the sidewalls 274, 275 may comprise the sealed bulkhead 160 having the sample ports 162 disposed thereon. The sample ports 162 may have a valve fitting (not shown) on the sealed bulkhead 160 which accepts connections to the test equipment 188. The valve fitting may be an integrated check valve having a normally closed position so that no air leaks out the fitting when the connection to the sample port 162 from the test equipment 188 is not present. The valve fitting may change to an open position to allow air to flow therethrough when the connection to the test equipment 188 is made to the valve fitting. The valve may be actuated automatically in response to mating with a connecting fitting, or manually, such as by a handle and the like.

The probe assemblies 152 may have one or more sample probes 212. The sample probes 212 have an opening 155 on the upstream side (i.e., the side of the probe 212 facing the internal flange 114) and a port 222 on the downstream side of the scan module 150. The particles of the challenge aerosol which may leak through the filter 112 enter the openings 155 when the sample probes 212 align with the leak in the filter. The size of the opening 155 is selected to have a design suitable for scan and/or efficiency testing of the filter. In one embodiment, the opening 155 of the probe 212 is selected to provide iso-kinetic sampling of the air passing through the filter, and may be additionally configured to conform to IEST-RP-CC034 Recommended Practices for filter scan testing. Air flowing into the opening 155 of the sample probe 212 exits the port 222.

In one embodiment, each probe assembly 152 may have four sample probes 212. Each opening 155 of the four sample probes 212 may be spaced about 1 inch from the downstream face of the filter 112, as shown in FIG. 1.

The openings 155 of adjacent sample probes 212 within the probe assembly 152 are aligned in a first direction and abut each other so that a narrow elongated area spanning from a top 253 to a bottom 254 of the probe assembly 152 is completely scanned by the probes 212. Thus, as the probe assembly 152 is advanced in a second direction that is perpendicular to the first direction, the sample probes 212 of the probe assembly 152 completely scan the entire width of the filter (in the first direction) over the distance the probe assembly 152 is displaced in the section direction. This ensures complete capture the airflow across the filter 112 without air passing around or between the probes 212.

The sample probes 212, 214, 216, 218 in the probe assemblies 152₁, 152₂, 152₂ may identify with sample ports 261, 262, 263 on a one to one basis. For example, air flowing into the opening 155 of sample probe 218₁ may exit port 228₁ and connect via a conduit 164 to the sample port 261₁. Alternately, the sample ports 162 may be configured to interact with more than one of the sample probes 212 or probe assemblies 152. The particles flowing into the sample probes 212, as discussed above, are directed to the sample ports for the test equipment 188 to measure the particle size and quantity in the air flow through a portion of the filter 112 where the sample probe 212 sampled the airflow. The presence of particles outside a threshold for size and quantity may be indicative of a defect in the filter, such as a pin hole in the location wherein the probe assembly 152 took the sample.

The probe assemblies 152 may have a bracket 250. The bracket 250 may attach or move on the support structure 248. The support structure 248 may hold the bracket 250 securely in the inner volume 272 of the scan module 150 while fluid flows therethrough. The support structure 248 may restrict the movement of the bracket 250 to maintain a specific orientation, movement, or elevation within the inner volume 272. For example, the support structure 248 may ensure the bracket 250 is aligned with the air flow. Thus the probe assemblies 152 are oriented to sample the airflow in an isokinetic manner as the airflow moves from the upstream side 206 to the downstream side 208 of the scan module 150.

The bracket 250 for the probe assemblies 152 may attach to a cross member 254 which spaces each probe assembly 152 to apart. The cross member 254 may be attached to a pull bar 154. The pull bar 154 may move the probe assemblies 152 attached to the bracket 250 across the face of the filter 112 for sampling the airflow. The pull bar 154 may alternately be incorporated into the upper or lower linear guides 244, 242. For example, the lower linear guide 242 may be fixed to the bracket 250 and thus moves the bracket as the lower linear guide 242 moves. Alternately, the upper linear guide 244 may be a threaded rod which is threaded through the bracket 250. As the upper linear guide 244 rotates, the bracket 250 moves in linearly along the threads of the upper linear guide 244.

The movement mechanism 156 provides a mechanism for moving the pull bar 154. The movement mechanism 156 may be configured to move in unison the brackets 250 supporting the probe assemblies 152 connected by the cross member 254. Thus, the movement mechanism 156 moves all the sample probes 212 in unison. The movement of the probe assemblies 152 is configured to provide a single complete scan of the filter 112. For example, the movement mechanism 156 may be a handle attached to the pull bar 154 which when pulled out 290, moves the probe assemblies 152 across the filter 112 for scanning.

The number of probe assemblies 152 shortens the stroke length, or reduces the amount of movement, necessary for the movement mechanism 156 to move the probe assemblies 152 entirely across the filter 112 to completely scan the filter 112. For example in an embodiment where the scan module 150 has two probe assemblies 152, the total stroke length will be half that if there was only a single probe assembly 152. In another embodiment where the scan module 150 has three probe assemblies 152, the stroke length will be a third that if there was only a single probe assembly 152. Thus, the more probe assemblies 152, the less stroke length required by the movement mechanism 156 to completely scan the filter 112 via the probe assembly 152.

In other embodiments, where the scan module 150 has two probe assemblies 152 and a 1×2 array of filters 112, both filters 112 tested with a single stroke of the probe assemblies 152. In another embodiment where the scan module 150 has four probe assemblies 152 and a 1×2 array of filters 112, both filters 112, the stroke length will be a have that if there was only a single probe assembly 152 when two probe assemblies 152 each cover half of each filter 112. Thus, the more probe assemblies 152, the less stroke length required by the movement mechanism 156 to completely scan the filters 112 via the probe assembly 152.

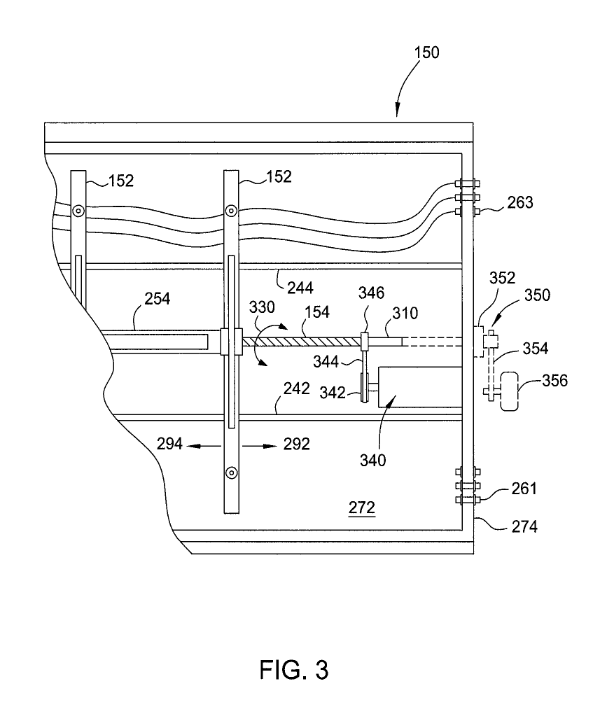

The movement mechanism 156 may be manually operated. The movement mechanism 156 may have a lever, a crank handle, a pull handle, or other suitable device. The movement mechanism 156 may alternatively be mechanized. The movement mechanism 156 may have a pneumatic cylinder, hydraulic cylinder, a linear motor, rotary motor, or other suitable device for providing movement. The movement mechanism may be extend through the sealed bulkhead and mount in the outside environment 190 or mount in the inner volume 186 of the housing or scan module 150. Discussion of the movement mechanism will be performed with reference taken to FIGS. 2 and 3. FIG. 3 is a partial plan view of the scan module 150 showing alternate movement mechanisms 156 for the probe assembly 152.

In one embodiment, the movement mechanism 156 is a single stroke pull handle as shown in FIG. 2. The linear movement of a pull handle type of movement mechanism 156 may cause the pull bar 154 to move the one or more probe assembles 152 non-intrusively across the filter 112 in a single sweep. Spacing between the probe assemblies 152, or the filter width in the case of a single probe assembly 152, will directly determine the stroke length of the movement mechanism 156. For instance, 8 inches between probe assemblies 152 may only require only 8 inches of pull on the handle of the movement mechanism 156. Advantageously, the complete scan of the filter 112 may only entail a single small stroke length for moving the movement mechanism 156 and thus allow the housing 102 to be placed in locations with limited room, i.e. operating space, and still permit rapid and accurate scanning of the filter 112.

In another embodiment, the movement mechanism 156 may be a crank handle 350, as shown in FIG. 3. The pull bar 154 may extend through a sealed bearing 352 on the sealed bulkhead 160 and attach to the crank handle 350. The crank handle 350 may have a fixed handle 354 with a knob 356. Rotating the knob 356 in a circular fashion may cause the crank handle 350 to rotate the movement mechanism 156. The pull bar 154, may be threaded through the cross member 254 or bracket 250 supporting the probe assemblies 152. By rotating the crank handle 350, the probe assemblies 152 may be made to advance across the face of the filter 112 by rotating the movement mechanism 156 through the treaded portion of the bracket 250. Introducing gears of different sizes between the crank handle 350 and the pull bar 154 may quicken or slow the advance of the probe assemblies 152 across the face of the filter 112 when rotating the movement mechanism 156, i.e. the crank handle 350. Alternately, the pull bar 154 may be a rack and the movement mechanism 156 may comprise a pinion which engages the rack upon the rotation of the crank handle 350.

In one embodiment, the movement mechanism 156 may comprise a motor 340. The motor 340 may be configured to interface with the movement mechanism and move the one or more probe assembles 152 non-intrusively across the filter 112 in a single sweep. The motor 340 may be mounting in the inner volume 186 or in the outside environment 190. The motor 340 may be a linear motor, rotary motor, a pneumatic or hydraulic actuator, such as a cylinder, or any other suitable device for providing movement. In one embodiment the motor 340 is a DC rotary motor attached to the movement mechanism 156 in the inner volume 186 of the scan module 150. The sealed bulkhead 160 may therefore be free of sealed bearing 352 and thus provide less avenues for possible fluid leaks. The motor 340 may have a controller (not shown) in the outside environment for controlling the movement provided by the motor 340 to the movement mechanism 156. The connection for the motor 340 to the controller may be wired through the sealed bulkhead 160. Alternately, the motor 340 may be have a wireless interface with the controller, such as a wireless magnetic induction or magnetic resonance, which may provide control and or power to the motor 340.

The motor 340 may have a coupling 341 for attaching to the movement mechanism 156. The coupling 341 may consist of linear or rotary motion assemblies such as racks, pinions, miter gears, bevel gears, worm gears, spur gears, bevel gears, pulleys, belts, idlers, cogs, cylinders assemblies, or other suitable devices for transferring power and motion. In one embodiment, the coupling 341 is comprised of a drive motor pulley 342 and a bar pulley 346 attached by a drive belt 344. The bar pulley 346 may be fixed to the pull bar 154. The pull bar 154 may be threaded and pass through a threaded portion of the bracket 250. The pull bar 154 is rotated by the bar pulley 346 attached by the drive belt 344 to the drive motor pulley 342 which in turn is driven to rotate by the motor 340. The bracket 250, fixed from rotating, is drawn linearly across the pull bar 154 threaded therethrough. Thus the motor 340 may advance the probe assemblies 152 across the face of the filter 112 in a single sweep for determining the rate or quantity of challenge aerosol bypassing through the filter 112.

The movement mechanism 156 is configured to sweep the probe assemblies 152 across the face of the filter 112 in a single sweep. Embodiments of the movement mechanism provide both manual and automatic advancement of the probe assemblies 152 extending transversely across the face of the filter 112. The advance of the probe assemblies 152 can be configured to match a rate suitable to meet any testing standard for measuring air flow passing through the filter 112. The air flow on passing through the filter 112 is captured by the probe assemblies 152 coupled by a conduit 164 to a downstream sample port 162 defined through the sealed bulkhead 160 and to the test equipment 188 for determining the quantity or rate of challenge aerosol passing through the filter 112. The probe assemblies 152 advantageously allow a single sweep across the filter 112 for testing of the filter 112. In this way the filter is tested less intrusively and quicker. Additionally, the probe assemblies 152 provides for alternate movement mechanisms 156 which allows the scan module 150 to be located with little clearance and accessibility.

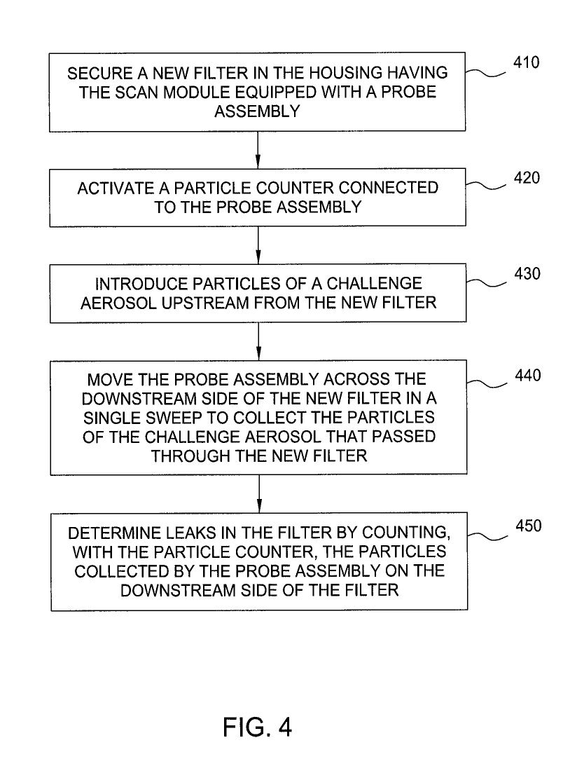

FIG. 4 illustrates a method for detecting leaks in a filter using the scan module. At block 410, one or more new filters are secured in the housing having the scan module equipped with one or more probe assemblies. A particle counter connected to the probe assembly is activated.

At block 430, a challenge aerosol having particles is introduced upstream from the new filter. At block 430 the one or more probe assemblies are moved across the downstream side of the one or more filters in a single sweep to collect the particles of the challenge aerosol that passed through the new filter. At block 440, leaks in the one or more filters are determined by counting, with the particle counter, the particles collected by the probe assemblies on the downstream side of the filters.

Although various embodiments which incorporate the teachings of the present invention have been shown and described in detail herein, those skilled in the art can readily devise many other varied embodiment that still incorporate these teachings.

What is claimed is:

1. A scan module, comprising:
a housing having a plurality of scan probes disposed therein; and
a movement mechanism coupled to the plurality of scan probes, the movement mechanism operable to simultaneously displace the plurality of scan probes within the housing.

2. The scan module of claim 1, wherein the housing further comprises:
a plurality of ports, each port connected to a respective one of the plurality of scan probes by a flexible conduit.

3. The scan module of claim 1, wherein the movement mechanism further comprise:
a single penetration.

4. The scan module of claim 1, wherein the movement mechanism further comprise:
an internal actuator.

5. The scan module of claim 1, wherein the plurality of scan probes are linearly aligned in a direction perpendicular to a direction of travel induced by the movement mechanism.

6. The scan module of claim 1, wherein the plurality of scan probes further comprises:
a first group of scan probes arranged to scan a first filter; and
a second group of scan probes arranged to scan a second filter.

7. The scan module of claim 6, wherein the first group of scan probes is linearly aligned with the second group of scan probes.

8. The scan module of claim 1, wherein the plurality of scan probes further comprises:
a first group of scan probes; and
a second group of scan probes arranged parallel to the first group of scan probes.

9. A filter housing assembly comprising:
a filter housing having an inlet, an outlet, a filter mount, and a filter access port; and
a scan module positioned between the filter mount and the outlet, the scan module comprising:
a plurality of scan probes; and
a movement mechanism coupled to the plurality of scan probes, the movement mechanism operable to simultaneously displace the plurality of scan probes in a direction perpendicular to a direction of air flow within the housing between the inlet and the outlet.

10. The filter housing assembly of claim 9 further comprising:
a plurality of ports, each port connected to a respective one of the plurality of scan probes by a flexible conduit.

11. The filter housing assembly of claim 9, wherein the movement mechanism further comprise:
a single penetration.

12. The filter housing assembly of claim 9, wherein the movement mechanism further comprise:
an internal actuator.

13. The filter housing assembly of claim 9, wherein the plurality of scan probes are linearly aligned in a direction perpendicular to a direction of travel induced by the movement mechanism.

14. The filter housing assembly of claim 9, wherein the plurality of scan probes further comprises:
a first group of scan probes arranged to scan a first filter; and
a second group of scan probes arranged to scan a second filter.

15. The filter housing assembly of claim 14, wherein the first group of scan probes is linearly aligned with the second group of scan probes.

16. The filter housing assembly of claim 9, wherein the plurality of scan probes further comprises:
a first group of scan probes; and
a second group of scan probes arranged parallel to the first group of scan probes.

17. The filter housing assembly of claim 16, wherein the first group of scan probes is configured to scan a first filter disposed in the filter housing and the second group of scan probes is configured to scan a second filter disposed in the filter housing.

18. A method for scanning a filter, the method comprising:
introducing a challenge aerosol upstream from a first filter secured in a housing;
simultaneously moving a first plurality of sample probes in a single sweep across a downstream face of the first filter; and
determining leaks in the first filter by utilizing samples collected by the probe assembly.

19. The method of claim 18 further comprising:
simultaneously moving a second plurality of sample probes in a single sweep across the downstream face of the first filter, the second plurality of sample probes disposed in parallel orientation relative to the first plurality of sample probes.

20. The method of claim 18 further comprising:
simultaneously moving a second plurality of sample probes in a single sweep across the downstream face of a second filter, the first and second plurality of sample probes coupled to a common movement mechanism.
